(19) United States
(12) Patent Application Publication
(10) Pub. No.: US 2026/0185956 A1
(43) Pub. Date: Jul. 2, 2026

(54) CLOSED LOOP CONTINUITY INSPECTION SYSTEM AND METHOD FOR VEHICLE PART QUALITY VERIFICATION

(71) Applicant: Volvo Car Corporation, Göteborg (SE)

(72) Inventor: David Joiner, Moncks Corner, SC (US)

(21) Appl. No.: 19/005,241

(22) Filed: Dec. 30, 2024

(51) Int. Cl. G01N 27/04; B23K 31/12

(52) U.S. Cl. CPC G01N 27/041; B23K 31/125

(57) ABSTRACT

A closed loop continuity inspection system and method for vehicle part quality verification and the like. The inspection system includes a test fixture that utilizes a plurality of test probes that extend from the test fixture to make contact with a plurality of sub-parts affixed to a part. Based on this contact, a controller coupled to the test probes is adapted to detect the presence/absence of each of the sub-parts and, in some embodiments, determine the relative quality of the interface between each sub-part and the part. Each of the test probes comprises a spring-loaded, conductive extensible probe tip that makes physical and electrical contact with the associated sub-part if the sub-part is present, but not if the sub-part is absent.

### INTRODUCTION

The present disclosure relates generally to the manufacturing and automotive fields. More particularly, the present disclosure relates to a closed loop continuity inspection system and method for vehicle part quality verification and the like.

In manufacturing, such as automotive manufacturing, the welding or connection of sub-parts to a part is ubiquitous. For example, nuts or bolts may be welded to a panel for the subsequent attachment of corresponding bolts or nuts, such that parts may be connected together or the part may be affixed to a vehicle. In such cases, it is necessary for quality assurance to verify if the sub-part is present and to determine if the sub-part is adequately affixed to the part, i.e., if the associated weld is of sufficient quality. Such quality assurance procedures can be difficult and time consuming.

Vision systems can be used for quality assurance, but such systems are expensive and typically limited to sub-part presence detection, and not sub-part attachment quality determination. Likewise, sensor systems can be used for quality assurance, but such systems are also complex and expensive, and require extra fixturing components to be on hand.

The present background is provided as environmental context only, and should not be construed to be limiting in any manner. It will be readily apparent to those of ordinary skill in the art that the principles and concepts of the present disclosure may be applied in other environmental contexts equally, without limitation.

### SUMMARY

The present disclosure provides a closed loop continuity inspection system and method for vehicle part quality verification and the like. The inspection system includes a test fixture that utilizes a plurality of test probes that extend from the test fixture to make contact with a plurality of sub-parts affixed to a part. Based on this contact, a controller coupled to the test probes is adapted to detect the presence/absence of each of the sub-parts and, in some embodiments, determine the relative quality of the interface between each sub-part and the part.

In some embodiments, each of the test probes comprises a spring-loaded, conductive extensible probe tip that makes physical and electrical contact with the associated sub-part if the sub-part is present, but not if the sub-part is absent. With a small voltage sent through each of the test probes through the test fixture, contact with the associated sub-part, if present, forms a dedicated closed loop to ground, thereby indicating the presence/absence of each of the sub-parts. Further, by monitoring the resistance of each of the closed loops, sub-part to test probe to ground, interface quality may be assessed. For example, better weld quality results in lower measured resistance.

The result is the simultaneous inspection of multiple affixed (or absent) sub-parts for a part coupled to the test fixture using a lightweight system and simple method. The use of parallel closed loops is less complex and expensive than the use of a vision system or attached sensor systems. Electrical feedback and electrical resistance measurements are tied to sub-part presence and weld quality, where a vision system or induction sensors can only see or determine the presence of a sub-part at considerable expense.

In some embodiments, the present disclosure provides a closed loop continuity inspection system, including: a test fixture adapted to be disposed adjacent to a part; and a plurality of test probes coupled to the test fixture and adapted to contact a plurality of sub-parts coupled to the part if the plurality of sub-parts are present on the part, thereby creating a closed electrical loop associated with each of the plurality of sub-parts indicating the presence of each of the plurality of sub-parts on the part, and protrude into a space intended for a sub-part coupled to the part if the sub-part is absent from the part, thereby not creating a closed electrical loop associated with the sub-part indicating the absence of the sub-part from the part. Each of the plurality of test probes is extensible from the test fixture. In some embodiments, each of the plurality of test probes includes a probe tip coupled to a spring member. The closed loop continuity inspection further includes a controller coupled to each of the plurality of test probes and adapted to receive a presence/absence signal from each of the plurality of test probes. The controller includes a display adapted to provide an indication to a user responsive to the presence/absence signal received from each of the plurality of test probes. In some embodiments, each of the plurality of test probes is adapted to provide an electrical resistance of each of the closed loops associated with the plurality of sub-parts contacted by the plurality of test probes, where the electrical resistance corresponds to an interface integrity between the part and the associated sub-part. The closed loop continuity inspection system further includes a controller coupled to each of the plurality of test probes and adapted to receive a signal from each of the plurality of test probes indicative of the provided electrical resistance. The controller includes a display adapted to provide an indication to a user responsive to the provided electrical resistance.

In some embodiments, the present disclosure provides a closed loop continuity inspection method, including: disposing a test fixture adjacent to a part; and contacting a plurality of sub-parts coupled to the part with a plurality of test probes coupled to the test fixture if the plurality of sub-parts are present on the part, thereby creating a closed electrical loop associated with each of the plurality of sub-parts indicating the presence of each of the plurality of sub-parts on the part, where a test probe of the plurality of test probes coupled to the test fixture protrudes into a space intended for a sub-part coupled to the part if the sub-part is absent from the part, thereby not creating a closed electrical loop associated with the sub-part indicating the absence of the sub-part from the part. Each of the plurality of test probes is extensible from the test fixture. In some embodiments, each of the plurality of test probes includes a probe tip coupled to a spring member. The closed loop continuity inspection method further includes receiving a presence/absence signal from each of the plurality of test probes at a controller coupled to each of the plurality of test probes. The controller includes a display adapted to provide an indication to a user responsive to the presence/absence signal received from each of the plurality of test probes. In some embodiments, each of the plurality of test probes is adapted to provide an electrical resistance of each of the closed loops associated with the plurality of sub-parts contacted by the plurality of test probes, where the electrical resistance corresponds to an interface integrity between the part and the associated sub-part. The closed loop continuity inspection method further includes receiving a signal from each of the plurality of test probes indicative of the provided electrical resistance at a controller coupled to each of the plurality of test probes. The controller includes a display adapted to provide an indication to a user responsive to the provided electrical resistance.

In some embodiments, the present disclosure provides a non-transitory computer-readable medium including instructions stored in a memory and executed by a processor to carry out closed loop continuity inspection method steps, including: correlating a plurality of signals received from a plurality of test probes coupled to a test fixture to presence/absence of a plurality of sub-parts on/from a part, where the plurality of test probes are adapted to contact the plurality of sub-parts coupled to the part if the plurality of sub-parts are present on the part, thereby creating a closed electrical loop associated with each of the plurality of sub-parts indicating the presence of each of the plurality of sub-parts on the part, and protrude into a space intended for a sub-part coupled to the part if the sub-part is absent from the part, thereby not creating a closed electrical loop associated with the sub-part indicating the absence of the sub-part from the part. Each of the plurality of test probes is extensible from the test fixture. In some embodiments, each of the plurality of test probes includes a probe tip coupled to a spring member. In some embodiments, the plurality of signals received from a plurality of test probes include an electrical resistance of each of the closed loops associated with the plurality of sub-parts contacted by the plurality of test probes, where the electrical resistance corresponds to an interface integrity between the part and the associated sub-part.

It will be readily apparent to those of ordinary skill in the art that features and aspects of the described embodiments may be included, omitted, or combined as desired in a given application.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a schematic diagram illustrating one embodiment of the closed loop continuity inspection system of the present disclosure;

FIG. 2 is a perspective view of one embodiment of the closed loop continuity inspection system of the present disclosure;

FIG. 3 is a perspective view of a sub-part with a relatively good weld quality, resulting in a relatively low resistance as measured by the closed loop continuity inspection system of the present disclosure;

FIG. 4 is a perspective view of a sub-part with a relatively poor weld quality, resulting in a relatively high resistance as measured by the closed loop continuity inspection system of the present disclosure;

FIG. 5 is a schematic diagram illustrating one embodiment of the closed loop continuity inspection method of the present disclosure;

FIG. 6 is a network diagram of a network-based system for implementing the various algorithms and functions of the present disclosure;

FIG. 7 is a block diagram of a server that may be used in the network-based system of FIG. 6 or stand-alone; and

FIG. 8 is a block diagram of a user device that may be used in the network-based system of FIG. 6 or stand-alone.

It will be readily apparent to those of ordinary skill in the art that features and aspects of the illustrated embodiments may be included, omitted, or combined as desired in a given application.

### DETAILED DESCRIPTION

Again, the present disclosure provides a closed loop continuity inspection system and method for vehicle part quality verification and the like. The inspection system includes a test fixture that utilizes a plurality of test probes that extend from the test fixture to make contact with a plurality of sub-parts affixed to a part. Based on this contact, a controller coupled to the test probes is adapted to detect the presence/absence of each of the sub-parts and, in some embodiments, determine the relative quality of the interface between each sub-part and the part.

In some embodiments, each of the test probes includes a spring-loaded, conductive extensible probe tip that makes physical and electrical contact with the associated sub-part if the sub-part is present, but not if the sub-part is absent. With a small voltage sent through each of the test probes through the test fixture, contact with the associated sub-part, if present, forms a dedicated closed loop to ground, thereby indicating the presence/absence of each of the sub-parts. Further, by monitoring the resistance of each of the closed loops, sub-part to test probe to ground, interface quality may be assessed. For example, better weld quality results in lower measured resistance.

The result is the simultaneous inspection of multiple affixed (or absent) sub-parts for a part coupled to the test fixture using a lightweight system and simple method. The use of parallel closed loops is less complex and expensive than the use of a vision system or attached sensor systems. Electrical feedback and electrical resistance measurements are tied to sub-part presence and weld quality, where a vision system or induction sensors can only see or determine the presence of a sub-part at considerable expense.

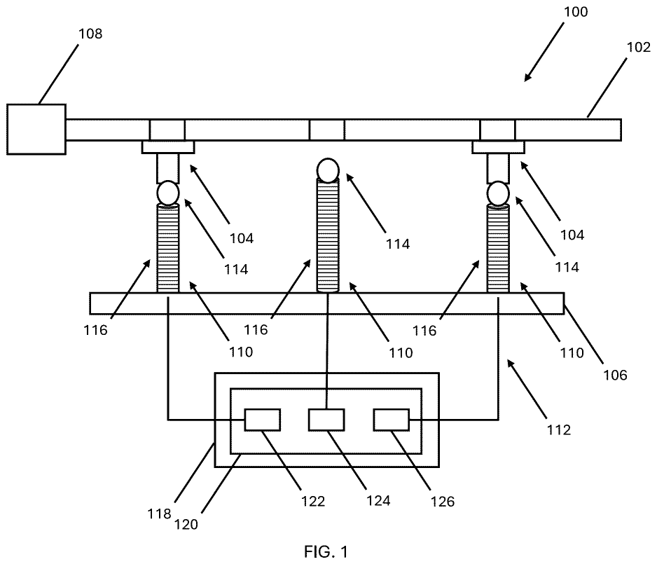

FIG. 1 is a schematic diagram illustrating one embodiment of the closed loop continuity inspection system 100 of the present disclosure. As shown for illustration purposes, the part 102 includes a plurality of affixed sub-parts 104 and a missing sub-part 104. For example, the part 102 may be a vehicle panel and the sub-parts 104 may be weld nuts that are welded to the vehicle panel. For quality assurance testing, the part 102 may be supported next to the test fixture 106 using a support structure 108. The test fixture 106 includes a plurality of test probes 110 that are extensible from the test fixture 106 to contact the associated sub-parts 104, if present. If a sub-part 104 is present, the contacting test probe 110 will form a closed loop 112 to ground for that sub-part 104, indicating the presence of the sub-part 104 on the part 102. If a sub-part 104 is not present, the open test probe 110 will not form a closed loop 112 to ground for that sub-part 104, indicating the absence of the sub-part 104 from the part 102. Thus, multiple parallel closed loops 112 that can be closed or open are used to detect the presence of multiple sub-parts 104 on the part 102.

In the embodiment illustrated, each of the test probes 110 includes a probe tip 114 that physically and electrically contacts the associated sub-part 104, and a conductive spring member 116 that extends the probe tip 114 from the test fixture 106 to contact the associated sub-part 104, if present. It will be readily apparent to those of ordinary skill in the art that other telescoping and/or compliant sub-part contact mechanisms may be utilized equally, provided that adequate physical and electrical contact are made with each sub-part 104, if present.

As is described in greater detail below, the quality of each sub-part-to-part interface may also be assessed by measuring the resistance associated with each closed loop 112, with relatively lower resistance indicating a relatively higher quality interface and relatively higher resistance indicating a relatively lower quality interface. This resistance-to-interface quality relationship may be quantified and calibrated such that relativistic measurements can be made.

A controller 118 is coupled to each of the test probes 110 that, based on the status of each of the closed/open loops 112, determines and indicates the presence/absence and, optionally interface quality of each of the sub-parts 104, optionally on a display 120. For example, the display 120 may indicate the presence of a sub-part 104 via a green indicator 122, the absence of a sub-part 104 via a red indicator 124, and/or the presence of a low quality interface via a yellow indicator 126. It will be readily apparent to those of ordinary skill in the art that other indication mechanisms may be used equally. Further, a programmable logic circuit (PLC) may be used to determine if everything is within a nominal predetermined range, with the PLC determining which “leg” has an issue and populating a fault code. Still further, these functionalities may be carried out by instructions stored in a memory and executed by a processor of the controller 118. Still further, resistance values may be collected and coupled with observations and assessments made using other methodologies such that the pass-fail and quality assessment algrithms may be updated periodically to enhance assessment performance.

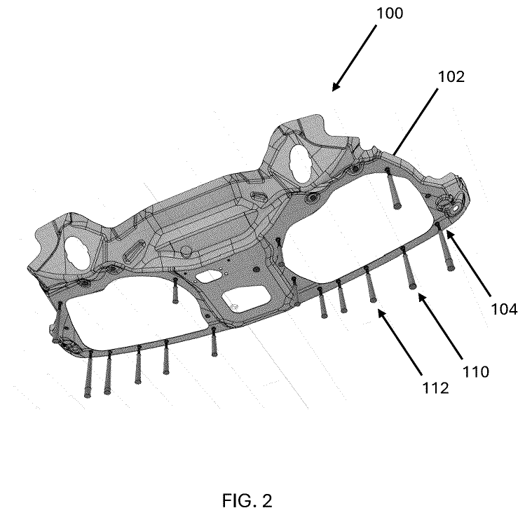

FIG. 2 is a perspective view of one embodiment of the closed loop continuity inspection system 100 of the present disclosure. Again, as shown for illustration purposes, the part 102 includes the plurality of affixed sub-parts 104. For example, the part 102 may be a vehicle panel and the sub-parts 104 may be weld nuts that are welded to the vehicle panel. For quality assurance testing, the part 102 may be supported next to the test fixture 106 using the support structure 108. The test fixture 106 includes the plurality of test probes 110 that are extensible from the test fixture 106 to contact the associated sub-parts 104, if present. If a sub-part 104 is present, the contacting test probe 110 will form the closed loop 112 to ground for that sub-part 104, indicating the presence of the sub-part 104 on the part 102. If a sub-part 104 is not present, the open test probe 110 will not form the closed loop 112 to ground for that sub-part 104, indicating the absence of the sub-part 104 from the part 102. Thus, the multiple parallel closed loops 112 that can be closed or open are used to detect the presence of multiple sub-parts 104 on the part 102.

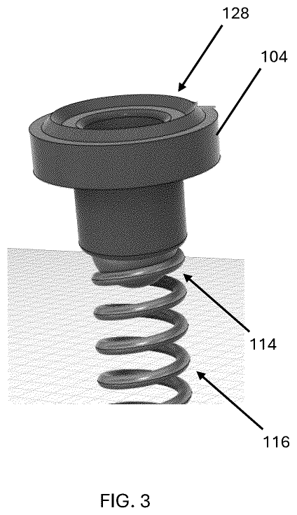

FIG. 3 is a perspective view of a sub-part 104 with a relatively good weld quality, resulting in a relatively low resistance as measured by the closed loop continuity inspection system 100 of the present disclosure. As shown, the wedge-shaped weld ridge 128 is a complete concentric structure, resulting in a good interface quality and a corresponding low resistance when measured through the probe tip 114 and spring member 116. Weld quality could also be enhanced or compromised based on the weld material, quality of the weld itself, etc.

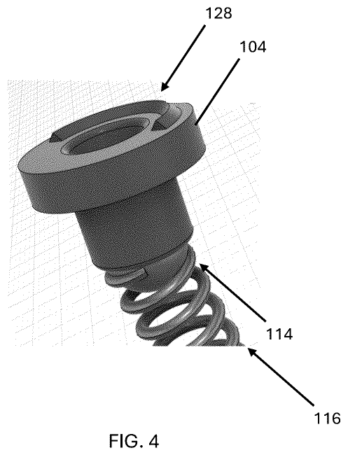

FIG. 4 is a perspective view of a sub-part 104 with a relatively poor weld quality, resulting in a relatively high resistance as measured by the closed loop continuity inspection system 100 of the present disclosure. As shown, the wedge-shaped weld ridge 128 is not a complete concentric structure, resulting in a poor interface quality and a corresponding high resistance when measured through the probe tip 114 and spring member 116. Again, weld quality could also be enhanced or compromised based on the weld material, quality of the weld itself, etc.

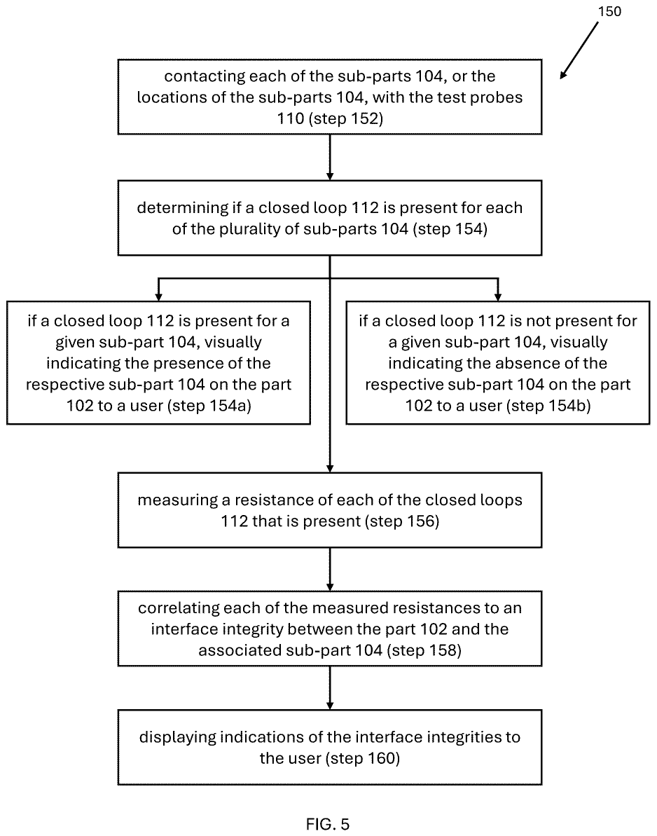

FIG. 5 is a schematic diagram illustrating one embodiment of the closed loop continuity inspection method 150 of the present disclosure. The method 150 generally includes contacting each of the sub-parts 104, or the locations of the sub-parts 104, with the test probes 110 (step 152). The method 150 then includes determining if a closed loop 112 is present for each of the plurality of sub-parts 104 (step 154). If a closed loop 112 is present for a given sub-part 104, visually indicating the presence of the respective sub-part 104 on the part 102 to a user (step 154a). If a closed loop 112 is not present for a given sub-part 104, visually indicating the absence of the respective sub-part 104 on the part 102 to a user (step 154b). The method 150 then includes measuring a resistance of each of the closed loops 112 that is present (step 156). The method 150 then includes correlating each of the measured resistances to an interface integrity between the part 102 and the associated sub-part 104 (step 158). Finally, the method includes displaying indications of the interface integrities to the user (step 160).

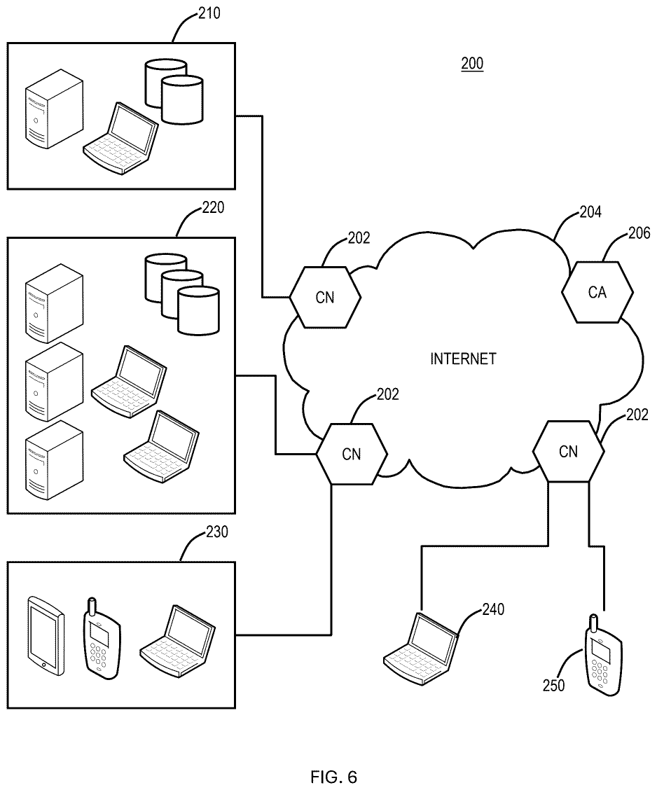

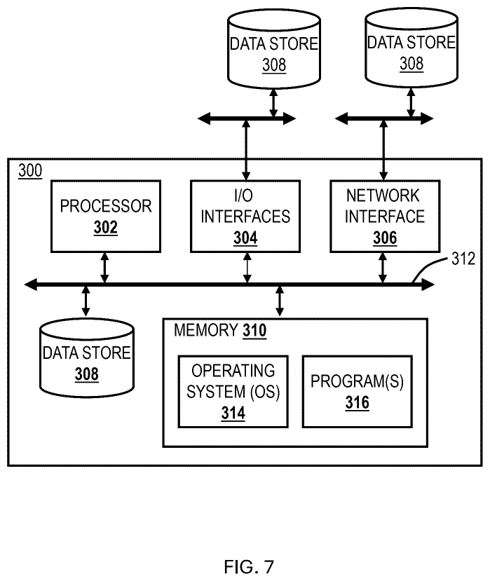

FIG. 6 is a network diagram of a network-based system 200 for implementing various network-based algorithms and functions of the present disclosure. The network-based system 200 includes one or more cloud nodes (CNs) 202 communicatively coupled to the Internet 204 or the like. The cloud nodes 202 may be implemented as a server 300 (as illustrated in FIG. 7) or the like and can be geographically diverse from one another, such as located at various data centers around the country or globe. Further, the network-based system 200 can include one or more central authority (CA) nodes 206, which similarly can be implemented as the server 300 and be connected to the CNs 202. For illustration purposes, the network-based system 200 can connect to a regional office 210, headquarters 220, various employee's homes 230, laptops/desktops 240, and mobile devices 250, each of which can be communicatively coupled to one of the CNs 202. These locations 210, 220, and 230, and devices 240 and 250 are shown for illustrative purposes, and those skilled in the art will recognize there are various access scenarios to the network-based system 200, all of which are contemplated herein. The devices 240 and 250 can be so-called road warriors, i.e., users off-site, on-the-road, etc. The network-based system 200 can be a private network, a public network, a combination of a private network and a public network (hybrid network), or the like.

The network-based system 200 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 210, 220, and 230 and devices 240 and 250. Previously, the Information Technology (IT) deployment model included enterprise resources and applications stored within an enterprise network (i.e., physical devices), behind a firewall, accessible by employees on site or remote via Virtual Private Networks (VPNs), etc. The network-based system 200 is replacing the conventional deployment model. The network-based system 200 can be used to implement these services in the cloud without requiring the physical devices and management thereof by enterprise IT administrators, for example.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The network-based system 200 is illustrated herein as one example embodiment of a network-based system, and those of ordinary skill in the art will recognize the systems and methods described herein are not necessarily limited thereby.

FIG. 7 is a block diagram of a server 300, which may be used in the network-based system 200 (FIG. 6), in other systems, or stand-alone, such as in a vehicle system. For example, the CNs 202 (FIG. 6) and the central authority nodes 206 (FIG. 6) may be formed as one or more of the servers 300. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 7 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example, but is not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chipset), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components.

The network interface 306 may be used to enable the server 300 to communicate on a network, such as the Internet 204 (FIG. 6). The network interface 306 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300, such as, for example, an internal hard drive connected to the local interface 312 in the server 300. Additionally, in another embodiment, the data store 308 may be located external to the server 300 such as, for example, an external hard drive connected to the I/O interfaces 304 (e.g., a SCSI or USB connection). In a further embodiment, the data store 308 may be connected to the server 300 through a network, such as, for example, a network-attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

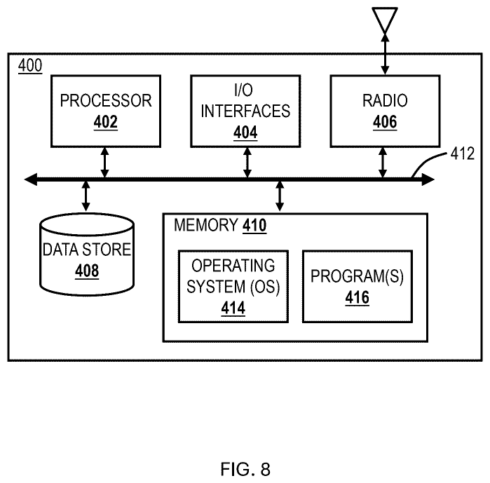

FIG. 8 is a block diagram of a user device 400, which may be used in the cloud-based system 200 (FIG. 6), as part of a network, or stand-alone, such as in a vehicle system. Again, the user device 400 can be a vehicle, a smartphone, a tablet, a smartwatch, an Internet of Things (IoT) device, a laptop, a virtual reality (VR) headset, etc. The user device 400 can be a digital device that, in terms of hardware architecture, generally includes a processor 402, I/O interfaces 404, a radio 406, a data store 408, and memory 410. It should be appreciated by those of ordinary skill in the art that FIG. 8 depicts the user device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example, but is not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a CPU, an auxiliary processor among several processors associated with the user device 400, a semiconductor-based microprocessor (in the form of a microchip or chipset), or generally any device for executing software instructions. When the user device 400 is in operation, the processor 402 is configured to execute software stored within the memory 410, to communicate data to and from the memory 410, and to generally control operations of the user device 400 pursuant to the software instructions. In an embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 406 enables wireless communication to an external access device or network. Any number of suitable wireless data communication protocols, techniques, or methodologies can be supported by the radio 306, including any protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

Again, the memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 8, the software in the memory 410 includes a suitable operating system 414 and programs 416. The operating system 414 essentially controls the execution of other computer programs and provides scheduling, input-output control, file and data management, memory management, and communication control and related services. The programs 416 may include various applications, add-ons, etc. configured to provide end user functionality with the user device 400. For example, example programs 416 may include, but not limited to, a web browser, social networking applications, streaming media applications, games, mapping and location applications, electronic mail applications, financial applications, and the like. In a typical example, the end-user typically uses one or more of the programs 416 along with a network, such as the network-based system 200 (FIG. 6).

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A closed loop continuity inspection system, comprising:
a test fixture adapted to be disposed adjacent to a part; and
a plurality of test probes coupled to the test fixture and adapted to contact a plurality of sub-parts coupled to the part if the plurality of sub-parts are present on the part, thereby creating a closed electrical loop associated with each of the plurality of sub-parts indicating the presence of each of the plurality of sub-parts on the part, and protrude into a space intended for a sub-part coupled to the part if the sub-part is absent from the part, thereby not creating a closed electrical loop associated with the sub-part indicating the absence of the sub-part from the part.

2. The closed loop continuity inspection system of claim 1, wherein each of the plurality of test probes is extensible from the test fixture.

3. The closed loop continuity inspection system of claim 1, wherein each of the plurality of test probes comprises a probe tip coupled to a spring member.

4. The closed loop continuity inspection system of claim 1, further comprising a controller coupled to each of the plurality of test probes and adapted to receive a presence/absence signal from each of the plurality of test probes.

5. The closed loop continuity inspection system of claim 4, wherein the controller comprises a display adapted to provide an indication to a user responsive to the presence/absence signal received from each of the plurality of test probes.

6. The closed loop continuity inspection system of claim 1, wherein each of the plurality of test probes is adapted to provide an electrical resistance of each of the closed loops associated with the plurality of sub-parts contacted by the plurality of test probes, wherein the electrical resistance corresponds to an interface integrity between the part and the associated sub-part.

7. The closed loop continuity inspection system of claim 6, further comprising a controller coupled to each of the plurality of test probes and adapted to receive a signal from each of the plurality of test probes indicative of the provided electrical resistance.

8. The closed loop continuity inspection system of claim 7, wherein the controller comprises a display adapted to provide an indication to a user responsive to the provided electrical resistance.

9. A closed loop continuity inspection method, comprising:
disposing a test fixture adjacent to a part; and
contacting a plurality of sub-parts coupled to the part with a plurality of test probes coupled to the test fixture if the plurality of sub-parts are present on the part, thereby creating a closed electrical loop associated with each of the plurality of sub-parts indicating the presence of each of the plurality of sub-parts on the part, wherein a test probe of the plurality of test probes coupled to the test fixture protrudes into a space intended for a sub-part coupled to the part if the sub-part is absent from the part, thereby not creating a closed electrical loop associated with the sub-part indicating the absence of the sub-part from the part.

10. The closed loop continuity inspection method of claim 9, wherein each of the plurality of test probes is extensible from the test fixture.

11. The closed loop continuity inspection method of claim 9, wherein each of the plurality of test probes comprises a probe tip coupled to a spring member.

12. The closed loop continuity inspection method of claim 9, further comprising receiving a presence/absence signal from each of the plurality of test probes at a controller coupled to each of the plurality of test probes.

13. The closed loop continuity inspection method of claim 12, wherein the controller comprises a display adapted to provide an indication to a user responsive to the presence/absence signal received from each of the plurality of test probes.

14. The closed loop continuity inspection method of claim 9, wherein each of the plurality of test probes is adapted to provide an electrical resistance of each of the closed loops associated with the plurality of sub-parts contacted by the plurality of test probes, wherein the electrical resistance corresponds to an interface integrity between the part and the associated sub-part.

15. The closed loop continuity inspection method of claim 14, further comprising receiving a signal from each of the plurality of test probes indicative of the provided electrical resistance at a controller coupled to each of the plurality of test probes.

16. The closed loop continuity inspection method of claim 5, wherein the controller comprises a display adapted to provide an indication to a user responsive to the provided electrical resistance.

17. A non-transitory computer-readable medium comprising instructions stored in a memory and executed by a processor to carry out closed loop continuity inspection method steps, comprising:
correlating a plurality of signals received from a plurality of test probes coupled to a test fixture to presence/absence of a plurality of sub-parts on/from a part, wherein the plurality of test probes are adapted to contact the plurality of sub-parts coupled to the part if the plurality of sub-parts are present on the part, thereby creating a closed electrical loop associated with each of the plurality of sub-parts indicating the presence of each of the plurality of sub-parts on the part, and protrude into a space intended for a sub-part coupled to the part if the sub-part is absent from the part, thereby not creating a closed electrical loop associated with the sub-part indicating the absence of the sub-part from the part.

18. The non-transitory computer-readable medium of claim 17, wherein each of the plurality of test probes is extensible from the test fixture.

19. The non-transitory computer-readable medium of claim 17, wherein each of the plurality of test probes comprises a probe tip coupled to a spring member.

20. The non-transitory computer-readable medium of claim 17, wherein the plurality of signals received from a plurality of test probes comprise an electrical resistance of each of the closed loops associated with the plurality of sub-parts contacted by the plurality of test probes, wherein the electrical resistance corresponds to an interface integrity between the part and the associated sub-part.
